(19) United States
(12) Patent Application Publication
(10) Pub. No.: US 2014/0229059 A1
(43) Pub. Date: Aug. 14, 2014

(54) DETECTING PRESENCE OF A PERSON IN A NON-RUNNING VEHICLE

(71) Applicant: FORD GLOBAL TECHNOLOGIES, LLC, Dearborn, MI (US)

(72) Inventors: Gopichandra Surnilla, West Bloomfield, MI (US); Karl Clark, Belleville, MI (US); Sergey Poberezhnyy, Detroit, MI (US); Richard E. Soltis, Saline, MI (US); Clay Wesley Maranville, Ypsilanti, MI (US)

(73) Assignee: FORD GLOBAL TECHNOLOGIES, LLC, Dearborn, MI (US)

(21) Appl. No.: 13/763,452

(22) Filed: Feb. 8, 2013

(51) Int. Cl. B60H 1/00

(52) U.S. Cl. CPC B60H 1/00742
USPC 701/36; 701/1

(57) ABSTRACT

A method, comprising during a vehicle off condition comprising when a vehicle engine is off, and the vehicle is parked, measuring a humidity of a vehicle cabin, and determining a presence of a passenger in the vehicle based on the humidity of the vehicle cabin. In some examples, cabin air may be circulated for a duration prior to the determination. The method may further include adjusting operation of an HVAC system of the vehicle responsive to a determination of a presence of a passenger in the vehicle.

### FIELD

The present description relates to motor vehicle operation.

### BACKGROUND AND SUMMARY

Detecting the presence of a passenger in a vehicle can be useful for various circumstances when the vehicle is stationary. For example, automatic adjustment of an heating, ventilation, and air-conditioning (HVAC) system may be performed responsive to the presence of a passenger in order to provide desired passenger comfort.

One example approach includes a method, comprising adjusting operation responsive to the presence of a passenger in the vehicle, the presence based on cabin humidity information. For example, the presence of the passenger may be based on humidity sensors that also provide information for control of the vehicle's HVAC system. By using such humidity sensors, it may be possible to provide improved automatic passenger comfort, while also utilizing the information to control HVAC operation to provide a desired set of HVAC conditions during stationary, and moving vehicle conditions. In this way, it may be possible to provide HVAC system operation with improved passenger comfort in response to the presence of the passenger in the vehicle, with not only the presence of the passenger based on humidity, but also feedback control of the HVAC system.

The above advantages as well as other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic of an example propulsion system for a vehicle, including an engine, energy storage device, fuel system, and motor.

FIG. 2 shows a schematic of an example engine, including a cylinder, exhaust-gas aftertreatment device, and engine controller, which may be included in the propulsion system of FIG. 1.

FIG. 3 illustrates a schematic view of an example vehicle configured with an HVAC system, and which may include the propulsion system of FIG. 1.

FIG. 4 illustrates an example of the HVAC system of FIG. 3.

FIG. 5 shows a schematic of an example dashboard in the front cabin of a vehicle, such as the vehicle of FIG. 3.

FIGS. 6-9 are example plots of humidity and temperature data with time.

FIG. 10 is a flow chart of an example routine for determining the presence of a passenger in a stationary vehicle that may be used with the vehicle of FIG. 3, for example.

### DETAILED DESCRIPTION

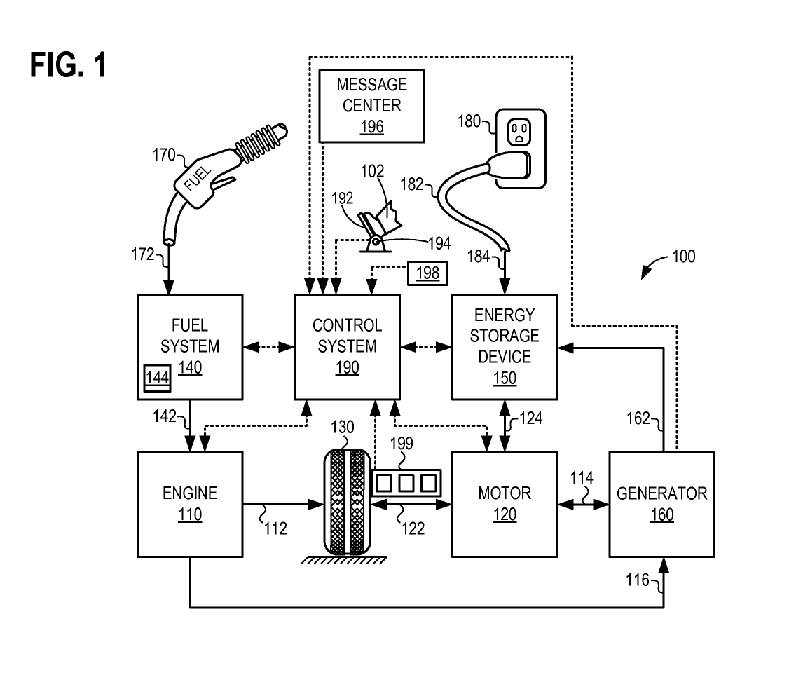

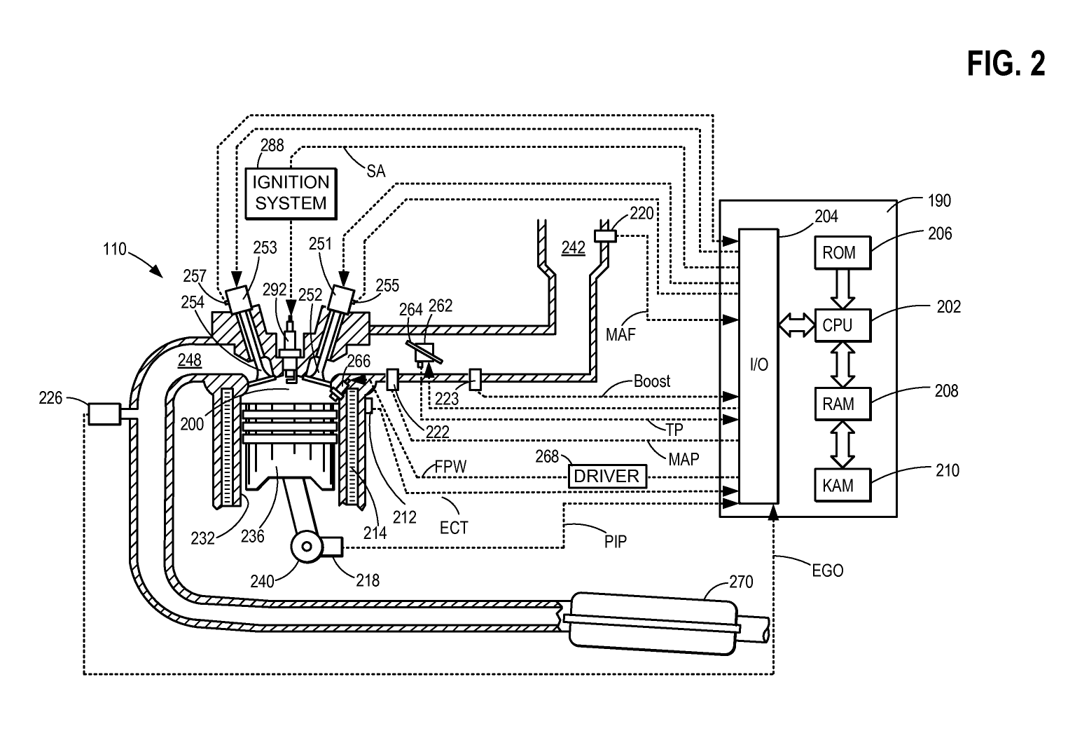

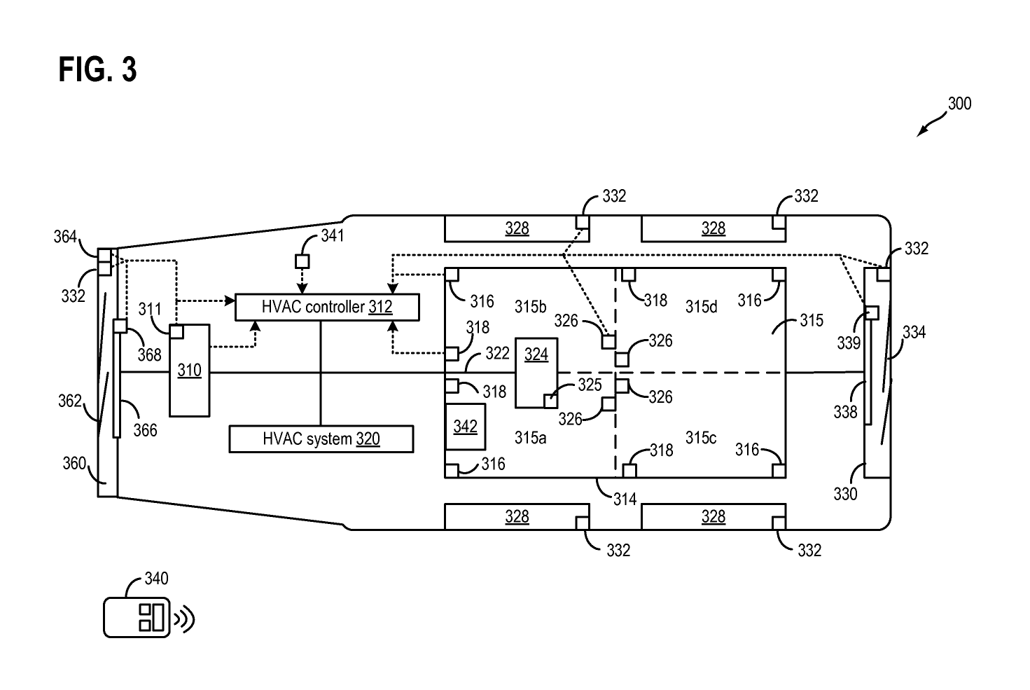

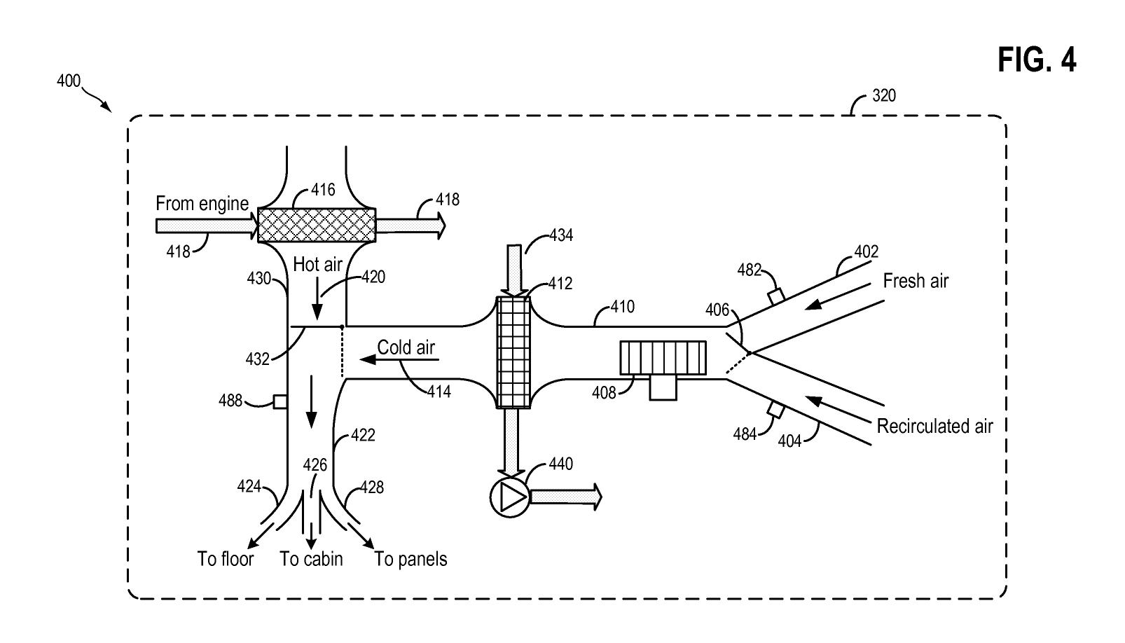

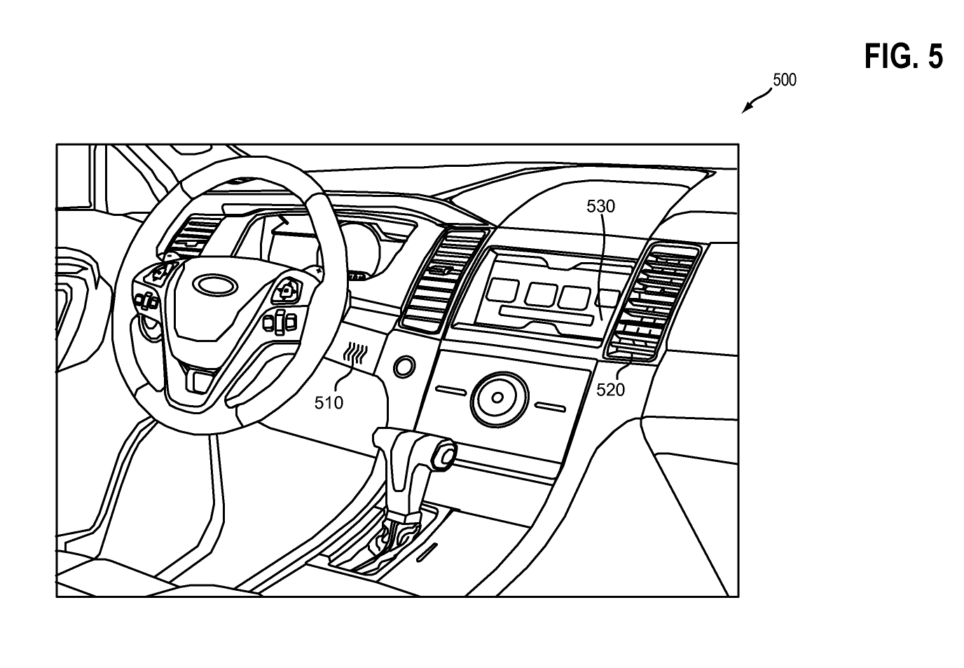

The following description relates to systems and methods for a vehicle, such as shown in FIG. 1, including an internal combustion engine, such as shown in FIG. 2, and a vehicle HVAC system, such as depicted in FIGS. 3 and 4 for detecting the presence of a passenger in a vehicle cabin. Example data correlating vehicle cabin humidity measurements to the presence of a passenger in a vehicle cabin are presented in FIGS. 5-8, and an example routine for using HVAC humidity sensors for detecting the presence of a passenger in a vehicle cabin is presented in FIG. 9.

Turning now to FIG. 1, it illustrates an example a vehicle propulsion system 100. Vehicle propulsion system 100 may comprise a fuel burning engine 110 and a motor 120. As a non-limiting example, engine 110 comprises an internal combustion engine and motor 120 comprises an electric motor. As such, vehicle propulsion system 100 may be a propulsion system for a hybrid-electric vehicle. However, vehicle propulsion system may also be a propulsion system for a non-hybrid vehicle, or an electric vehicle with an electric motor and no combustion engine. Motor 120 may be configured to utilize or consume a different energy source than engine 110. For example, engine 110 may consume a liquid fuel (e.g., gasoline) to produce an engine output while motor 120 may consume electrical energy to produce a motor output. As such, a vehicle with propulsion system 100 may be referred to as a hybrid electric vehicle (HEV). In other examples, where the vehicle propulsion system 100 is for an electric vehicle, vehicle propulsion system may be referred to as an electric vehicle (EV).

Vehicle propulsion system 100 may utilize a variety of different operational modes depending on operating conditions encountered by the vehicle propulsion system. Some of these modes may enable engine 110 to be maintained in an off state (e.g. set to a deactivated state) where combustion of fuel at the engine is discontinued. For example, under select operating conditions, motor 120 may propel the vehicle via drive wheel 130 as indicated by arrow 122 while engine 110 is deactivated.

During other operating conditions, engine 110 may be set to a deactivated state (as described above) while motor 120 may be operated to charge energy storage device 150 such as a battery. For example, motor 120 may receive wheel torque from drive wheel 130 as indicated by arrow 122 where the motor may convert the kinetic energy of the vehicle to electrical energy for storage at energy storage device 150 as indicated by arrow 124. This operation may be referred to as regenerative braking of the vehicle. Thus, motor 120 can provide a generator function in some examples. However, in other examples, generator 160 may instead receive wheel torque from drive wheel 130, where the generator may convert the kinetic energy of the vehicle to electrical energy for storage at energy storage device 150 as indicated by arrow 162.

During still other operating conditions, engine 110 may be operated by combusting fuel received from fuel system 140 as indicated by arrow 142. For example, engine 110 may be operated to propel the vehicle via drive wheel 130 as indicated by arrow 112 while motor 120 is deactivated. During other operating conditions, both engine 110 and motor 120 may each be operated to propel the vehicle via drive wheel 130 as indicated by arrows 112 and 122, respectively. A configuration where both the engine and the motor may selectively propel the vehicle may be referred to as a parallel type vehicle propulsion system. Note that in some examples, motor 120 may propel the vehicle via a first set of drive wheels and engine 110 may propel the vehicle via a second set of drive wheels.

In other examples, vehicle propulsion system 100 may be configured as a series type vehicle propulsion system, whereby the engine does not directly propel the drive wheels. Rather, engine 110 may be operated to power motor 120, which may in turn propel the vehicle via drive wheel 130 as indicated by arrow 122. For example, during select operating conditions, engine 110 may drive generator 160, which may in turn supply electrical energy to one or more of motor 120 as indicated by arrow 114 or energy storage device 150 as indicated by arrow 162. As another example, engine 110 may be operated to drive motor 120 which may in turn provide a generator function to convert the engine output to electrical energy, where the electrical energy may be stored at energy storage device 150 for later use by the motor. The vehicle propulsion system may be configured to transition between two or more of the operating modes described above depending on vehicle operating conditions. As another example, vehicle propulsion system may be a propulsion system for an electric vehicle (e.g., with no combustion engine), wherein an electric motor receiving electric power from energy storage device 150 (e.g., a battery) may propel the vehicle.

Fuel system 140 may include one or more fuel tanks 144 for storing fuel on-board the vehicle. For example, fuel tank 144 may store one or more liquid fuels, including but not limited to gasoline, diesel, and alcohol fuels. In some examples, the fuel may be stored on-board the vehicle as a blend of two or more different fuels. For example, fuel tank 144 may be configured to store a blend of gasoline and ethanol (e.g. E10, E85, etc.) or a blend of gasoline and methanol (e.g. M10, M85, etc.), whereby these fuels or fuel blends may be delivered to engine 110 as indicated by arrow 142. Still other suitable fuels or fuel blends may be supplied to engine 110, where they may be combusted at the engine to produce an engine output. The engine output may be utilized to propel the vehicle as indicated by arrow 112 or to recharge energy storage device 150 via motor 120 or generator 160.

In some examples, energy storage device 150 may be configured to store electrical energy that may be supplied to other electrical loads residing on-board the vehicle (other than the motor), including cabin heating and air conditioning, engine starting, headlights, cabin audio and video systems, an exhaust-gas grid heater, an exhaust-gas recycle cooler, etc. As a non-limiting example, energy storage device 150 may include one or more batteries and/or capacitors.

Control system 190 may communicate with one or more of engine 110, motor 120, fuel system 140, energy storage device 150, and generator 160. As will be described in FIG. 2, control system 190 may comprise controller 211 and may receive sensory feedback information from one or more of engine 110, motor 120, fuel system 140, energy storage device 150, and generator 160. Further, control system 190 may send control signals to one or more of engine 110, motor 120, fuel system 140, energy storage device 150, and generator 160 responsive to this sensory feedback. Control system 190 may receive an indication of an operator requested output of the vehicle propulsion system from a vehicle operator 102. For example, control system 190 may receive sensory feedback from pedal position sensor 194 which communicates with pedal 192. Pedal 192 may refer schematically to a brake pedal and/or an accelerator pedal.

Energy storage device 150 may periodically receive electrical energy from a power source 180 residing external to the vehicle (e.g. not part of the vehicle) as indicated by arrow 184. As a non-limiting example, vehicle propulsion system 100 may be configured as a plug-in hybrid electric vehicle (HEV), whereby electrical energy may be supplied to energy storage device 150 from power source 180 via an electrical energy transmission cable 182. As a further non-limiting example, vehicle propulsion system 100 may be configured as a plug-in electric vehicle (EV), whereby electrical energy may be supplied to energy storage device 150 from power source 180 via an electrical energy transmission cable 182. Control system 190 may further control the output of energy or power from energy storage device 150 (e.g., a battery) depending on the electric load of vehicle propulsion system 100. For example, during reduced electrical load operation, control system 190 may step-down the voltage delivered from energy storage device 150, via a an inverter/converter, in order to save energy.

During a recharging operation of energy storage device 150 from power source 180, electrical transmission cable 182 may electrically couple energy storage device 150 and power source 180. While the vehicle propulsion system is operated to propel the vehicle, electrical transmission cable 182 may be disconnected between power source 180 and energy storage device 150. Control system 190 may identify and/or control the amount of electrical energy stored at the energy storage device, which may be referred to as the state of charge (state-of-charge).

In other examples, electrical transmission cable 182 may be omitted, where electrical energy may be received wirelessly at energy storage device 150 from power source 180. For example, energy storage device 150 may receive electrical energy from power source 180 via one or more of electromagnetic induction, radio waves, and electromagnetic resonance. As such, it will be appreciated that any suitable approach may be used for recharging energy storage device 150 from a power source that does not comprise part of the vehicle. In this way, motor 120 may propel the vehicle by utilizing an energy source other than the fuel utilized by engine 110.

Fuel system 140 may periodically receive fuel from a fuel source residing external to the vehicle. As a non-limiting example, vehicle propulsion system 100 may be refueled by receiving fuel via a fuel dispensing device 170 as indicated by arrow 172. In some examples, fuel tank 144 may be configured to store the fuel received from fuel dispensing device 170 until it is supplied to engine 110 for combustion.

A plug-in hybrid electric vehicle, as described with reference to vehicle propulsion system 100, may be configured to utilize a secondary form of energy (e.g.

electrical energy) that is periodically received from an energy source that is not otherwise part of the vehicle.

The vehicle propulsion system 100 may also include a message center 196, ambient temperature/humidity sensor 198, electrical load sensor 154, and a roll stability control sensor, such as a lateral and/or longitudinal and/or steering wheel position or yaw rate sensor(s) 199. The message center may include indicator light(s) and/or a text-based display in which messages are displayed to an operator, such as a message requesting an operator input to start the engine, as discussed below. The message center may also include various input portions for receiving an operator input, such as buttons, touch screens, voice input/recognition, GPS device, etc. As another example, the message center may communicate audio messages to the operator without display. Further, the sensor(s) 199 may include a vertical accelerometer to indicate road roughness. These devices may be connected to control system 190. In one example, the control system may adjust engine output and/or the wheel brakes to increase vehicle stability in response to sensor(s) 199.

Referring now to FIG. 2, it illustrates a non-limiting example of a cylinder 200 of engine 110, including the intake and exhaust system components that interface with the cylinder. Note that cylinder 200 may correspond to one of a plurality of engine cylinders.

Cylinder 200 is at least partially defined by combustion chamber walls 232 and piston 236. Piston 236 may be coupled to a crankshaft 240 via a connecting rod, along with other pistons of the engine. Crankshaft 240 may be operatively coupled with drive wheel 130, motor 120 or generator 160 via a transmission.

Cylinder 200 may receive intake air via an intake passage 242. Intake passage 242 may also communicate with other cylinders of engine 110. Intake passage 242 may include a throttle 262 including a throttle plate 264 that may be adjusted by control system 190 to vary the flow of intake air that is provided to the engine cylinders. Cylinder 200 can communicate with intake passage 242 via one or more intake valves 252. Cylinder 200 may exhaust products of combustion via an exhaust passage 248. Cylinder 200 can communicate with exhaust passage 248 via one or more exhaust valves 254.

In some examples, cylinder 200 may optionally include a spark plug 292, which may be actuated by an ignition system 288. A fuel injector 266 may be provided in the cylinder to deliver fuel directly thereto. However, in other examples, the fuel injector may be arranged within intake passage 242 upstream of intake valve 252. Fuel injector 266 may be actuated by a driver 268.

A non-limiting example of control system 190 is depicted schematically in FIG. 2. Control system 190 may include a processing subsystem (CPU) 202, which may include one or more processors. CPU 202 may communicate with memory, including one or more of read-only memory (ROM) 206, random-access memory (RAM) 208, and keep-alive memory (KAM) 210. As a non-limiting example, this memory may store instructions that are executable by the processing subsystem. The process flows, functionality, and methods described herein may be represented as instructions stored at the memory of the control system that may be executed by the processing subsystem.

CPU 202 can communicate with various sensors and actuators of engine 110, energy storage device 150, and fuel system 140 via an input/output device 204. As a non-limiting example, these sensors may provide sensory feedback in the form of operating condition information to the control system, and may include: an indication of mass airflow (MAF) through intake passage 242 via sensor 220, an indication of manifold air pressure (MAP) via sensor 222, an indication of throttle position (TP) via throttle 262, an indication of engine coolant temperature (ECT) via sensor 212 which may communicate with coolant passage 214, an indication of engine speed (PIP) via sensor 218, an indication of exhaust gas oxygen content (EGO) via exhaust gas composition sensor 226, an indication of intake valve position via sensor 255, an indication of exhaust valve position via sensor 257, and an indication of electrical load via electrical load sensor 154, among others. Electrical load sensor 154 may, as an example, be a current transformer that monitors the amount of current vehicle propulsion system 100 is drawing from the battery.

Furthermore, the control system 190 may control operation of the engine 110, including cylinder 200 via one or more of the following actuators: driver 268 to vary fuel injection timing and quantity, ignition system 288 to vary spark timing and energy, intake valve actuator 251 to vary intake valve timing, exhaust valve actuator 253 to vary exhaust valve timing, and throttle 262 to vary the position of throttle plate 264, among others. Note that intake and exhaust valve actuators 251 and 253 may include electromagnetic valve actuators (EVA) and/or cam-follower based actuators.

FIG. 3 shows a schematic depiction of a vehicle 300 equipped with an HVAC system 320. The vehicle may include a cabin space 314. The cabin space may be divided into occupancy zones 315. In one example, vehicle 300 may be a four-passenger vehicle. Accordingly, cabin space 314 may be divided into four occupancy zones including a front left side driver zone 315a, a front right side passenger zone 315b, a rear left side passenger zone 315c, and a rear right side passenger zone 315d.

HVAC system 320 may be configured to provide a climate-controlled air flow to cabin space 314 through ducting 322 and one or a plurality of vents 324. While the depicted example shows a common vent for the entire cabin space, it will be appreciated that other examples, each occupancy zone may be serviced by distinct vents to enable each passenger to control the climate (for example, the temperature) of their occupancy zone. HVAC system 320 may additionally provide a climate-controlled air flow to the vehicle floors and panels through appropriate ducting. Vent 324 may also comprise vent sensor 325, which can provide HVAC controller 312, for example, with an input indication of the blower motor speed, the direction of air flow from the vent, and the duration of time and the degree the vent is open.

Cabin space 314 may be equipped with a temperature sensor 318 to provide feedback to an HVAC controller 312 regarding the temperature conditions in the cabin space. In one example, temperature sensor 318 may be a temperature sensor providing feedback regarding the average ambient temperature of the cabin space. In another example, each occupancy zone may be equipped with a distinct temperature sensor 318 to provide feedback to HVAC controller 312 regarding the temperature conditions within each occupancy zone. Alternatively, the signal provided from the distinct temperature sensors 318 may be combined and arranged in HVAC controller 312 to provide a control input signal representative of the ambient temperature of the cabin space 314.

Cabin space 314 may also be equipped with sun load sensor 326 to provide a signal indicative of the solar load received from each window of a respective occupancy zone 315 to HVAC controller 312. The vehicle 300 may additionally be equipped with fore and aft sun load sensors on the sun/moon roof or front and back windows of the vehicle. The signal provided from the sun load sensors 326 may be combined and arranged in HVAC controller 312 to provide a control input signal representative of the solar radiation intensity on the vehicle interior. Alternatively, the signals from the distinct sun load sensors may be used individually as a control input signal representative of the solar radiation intensity of each occupancy zone 315. Alternatively, the fore and/or aft sun load sensor may be used to provide a combined or individual solar intensity signal to the HVAC controller 312.

The vehicle 300 may be configured with four side windows 328, each included as an element of four vehicle doors. As another example, the vehicle may be configured with two windows, each included as an element of two vehicle doors. Additionally, the vehicle 300 may include a rear window 330 that may be part of a rear vehicle door, and a roof window 350, for example a sunroof or moon roof. The roof window may also comprise a convertible top, for example, a soft top, a jeep-style removable canvas, a hard top or a t-roof. The rear vehicle window may also comprise a hatch, or larger portals such as a bus door, no door (for example, as in some delivery vehicles), portals with no window panes, and the like.

Each vehicle window 328, rear window 330, and roof window 350 may include a window sensor 332 configured to provide an indication to the HVAC controller 312 of the closed or open position of the window. Window sensors 332 may represent one or a plurality of sensors at each window further configured to provide an indication of the open state of the window. For example, window sensor 332 can measure the temperature and relative humidity at the interior window surface, and can indicate a percentage of full-open state and/or the time elapsed since the window was opened. In addition to rear window 330, vehicle 300 can further include rear window wipers 334, rear window defroster 336, rear window vent 338, and rear window vent sensor 339. Window sensor 332, rear window defroster 336, rear window vent 338 and rear window vent sensor 339 may provide inputs to the HVAC controller 312. Rear windshield vent sensor 339, can provide HVAC controller 312 with an input indication, for example, of the blower speed and the duration of time and the degree the rear windshield vent 338 is open.

Additional sensors, such as an indoor cabin humidity sensor, an altitude sensor, and an air quality sensor may also be included in cabin space 314 (or each occupancy zone 315) and may provide inputs to the HVAC controller 312. For example, a humidity sensor may be placed at the rearview mirror. The outdoor ambient temperature/relative humidity sensor 198 may also provide input to the HVAC controller 312. HVAC controller 312 may also receive an indication of the ignition state of engine 310 from an ignition sensor 311. Vehicle 300 may further include a key fob sensor 341 configured to receive input from electronic key fob 340. Specifically, key fob sensor 341 may remotely couple the vehicle 300 to electronic key fob 340, thereby enabling a remote keyless entry into vehicle 300. Key fob sensor 341 may be configured to provide an indication to HVAC controller 312 regarding the locked or unlocked position of the vehicle doors.

HVAC controller 312 may be a microprocessor based controller including a central processing unit (CPU) and associated memory, such as read only memory (ROM), random access memory (RAM), and keep alive memory (KAM), as well as input and output ports for receiving information from, and communicating information to, the various sensors, vents, and climate-control interfaces.

HVAC controller 312 may operate HVAC system 320 in response to passenger-selected settings, for example, a temperature and direction of air flow. Specifically, in response to the passenger-selected settings, the controller may monitor and process the various inputs received from the plurality of sun load sensors 326, temperature sensors 318, window sensors 332, etc., to accordingly adjust the function of the HVAC heating and cooling components (see FIG. 4), such as the evaporator 412, the blower 408, and the heater 416, to thereby maintain the desired temperature and direction of air flow. HVAC controller may, under certain conditions, also operate windows 328 and other vehicle portals.

Now turning to FIG. 4, an example 400 of the components and operation of a vehicle HVAC system 320 is described. As such, the temperature and flow of air supplied to the vehicle's cabin space may be adjusted by adjusting a ratio of hot air (generated using heating elements) and cold air (generated using cooling elements). HVAC system 320 includes a fresh air duct 402 for providing fresh air from outside the vehicle, and a recirculated air duct 404 for providing recirculated air from inside the vehicle cabin. A ratio of fresh air to recirculated air is adjusted by actuator 406 responsive to selected HVAC settings. For example, when a higher proportion of recirculated air is needed, the actuator may be positioned near the mouth of fresh air duct 402 (as shown in solid lines). Alternatively, when a higher proportion of fresh air is needed, the actuator may be positioned near the mouth of recirculated air duct 404 (as shown in dotted lines). Actuator 406 may be driven between the various positions by a vacuum motor (not shown). Alternatively, actuator 406 may be driven by an electric servo motor.

Sensors 482 and 486 may be located in fresh air duct 402 and recirculated air duct 404 respectively for measuring temperature and/or humidity (e.g., relative humidity) of the incoming fresh air or the recirculated air from the vehicle cabin. Measurements from sensors 482 and 486 may be transmitted to HVAC controller 312 and used as inputs for controlling the vehicle HVAC system 320.

The appropriate mixture of fresh and recirculated air is then passed through HVAC cooling elements, configured to enable air-conditioning. Specifically, the air is passed through blower 408 and evaporator core 412 along conduit 410. Blower 408 includes a variable speed blower motor and a blower wheel or fan. Inside evaporator core 412, the evaporation of a low pressure cooling fluid or refrigerant 434 (for example, freon) into a low pressure gas causes a cooling effect which in turn cools the air flowing across it. Based on the temperature and/or humidity settings of the HVAC system, a suitable proportion of cold air 414, cooled by passage through evaporator core 412, may then be passed into ducting 422 and distributed to the cabin via vents 324, front windshield vent 366 and rear window vent 338. After exiting the evaporator core, the refrigerant vapor passes through a compressor 440, emerging as a hot compressed gas. The hot compressed refrigerant gas is subsequently passed through a condenser (not shown), becoming a cooled compressed liquid, after which it is fed through an expansion valve (not shown), becoming a cold liquid/vapor mixture, before finally being reintroduced into the evaporator core 412.

Hot air 420 may be generated by passage of fresh and/or recirculated air through HVAC heating elements, configured to enable air heating. Specifically, air is passed through a heater core 416. Engine coolant 418, received from the engine, is circulated through the heater core. Heater core 416 may then behave as a heat exchanger, withdrawing heat from the engine coolant and transferring the withdrawn heat to air passing across it. In this way, hot air may be generated in conduit 430 and passed into ducting 422. A climate-controlled air flow comprising a suitable amount of hot air and cold air may be generated in ducting 422, for subsequent passage to vehicle vents. Specifically, a ratio of hot air 420 to cold air 414 may be adjusted by actuator 432 responsive to selected HVAC temperature and/or humidity settings. For example, when air flow of a higher temperature is requested, the actuator may be positioned near the mouth of cold air conduit 410 (as shown in dotted lines). Alternatively, when air flow of a lower temperature is requested, the actuator may be positioned near the mouth of hot air conduit 430 (as shown in solid lines). Actuator 432 may be driven by a vacuum motor or an electric servo motor (not shown). The air flow with the requested settings of flow rate and temperature may then be directed along ducting 424, 426 and/or 428 to the vehicle floor, cabin space and panels, respectively, responsive to the passenger-indicated direction of air flow.

Sensor 488 may be located in ducting 422 for measuring the temperature and/or relative humidity of the air flow directed back to the cabin through ducting 424, 426, and/or 428. Measurements from sensor 488 may be transmitted to HVAC controller 312 and used as inputs for controlling the vehicle HVAC system 320.

In this way, the heating and cooling elements of HVAC system 320 may be used to deliver an air flow with an appropriate ratio of hot and cold air to a requested location, with a requested flow rate, to thereby provide the vehicle passengers with a climate-controlled air flow.

Turning now to FIG. 5, it illustrates a schematic of an example front instrument panel 500 of a vehicle cabin. In addition to humidity sensors 482, 484, 488 described in FIG. 4, vehicle sensors may further comprise a temperature and/or humidity sensor 510 located near the steering wheel. Humidity sensor 510 may be used to measure the humidity near the driver compartment of the vehicle cabin. Furthermore, one or more humidity sensors 520 may be present inside HVAC ducting, for example, similar to sensors 482, 484, and 488. Electronic display 530 may be a touch display panel for receiving passenger input and for outputting visual and audio signals to the vehicle passengers. For example, electronic display 530 may output temperature and humidity data, including calculated humidity data such as relative humidity, specific humidity, and absolute humidity.

Humidity relates to the concentration of water in an air-water mixture. Relative humidity (RH) is defined as the ratio of the partial vapor pressure of water to the saturation vapor pressure of water at a prescribed temperature. Specific humidity (SH) is defined as the ratio of the mass of water vapor to the total mass of air and water vapor. Absolute humidity (AH) is defined as the ratio of the mass of water vapor to the total volume. Humidity sensors commonly measure RH, from which SH and AH can be calculated using known physical properties of air and water.

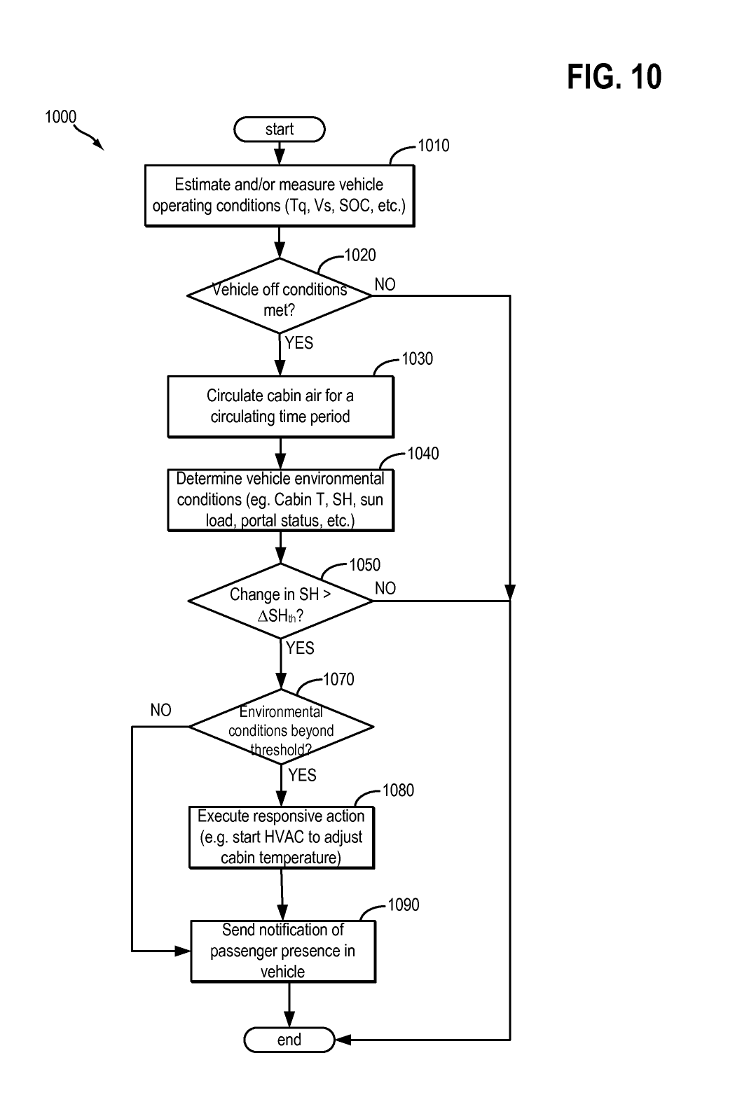

HVAC controller 312 may operate HVAC system 320 in response to passenger-selected settings, for example, a temperature and direction of air flow. Specifically, in response to the passenger-selected settings when the vehicle is in motion, the controller may monitor and process the various inputs received from the plurality of humidity sensors (e.g. 198, 482, 484, 488, 510, 520), sun load sensors 326, temperature sensors 318, window sensors 332, etc., to accordingly adjust the function of the HVAC heating and cooling components to thereby maintain the desired temperature and direction of air flow. Furthermore, HVAC controller 312 may also be configured to detect the presence of a passenger, and monitor and control vehicle cabin humidity when the vehicle is stationary, and/or parked with the engine off (see FIG. 10).

In this manner, a system may comprise a vehicle with an HVAC system, a humidity sensor, and a controller for adjusting the HVAC system based on a humidity to provide an operator-indicated cabin environmental condition (e.g., temperature) during a first vehicle on mode, and for adjusting the HVAC system responsive to presence of a passenger in the vehicle, the passenger presence based on the humidity sensor, during a vehicle off mode.

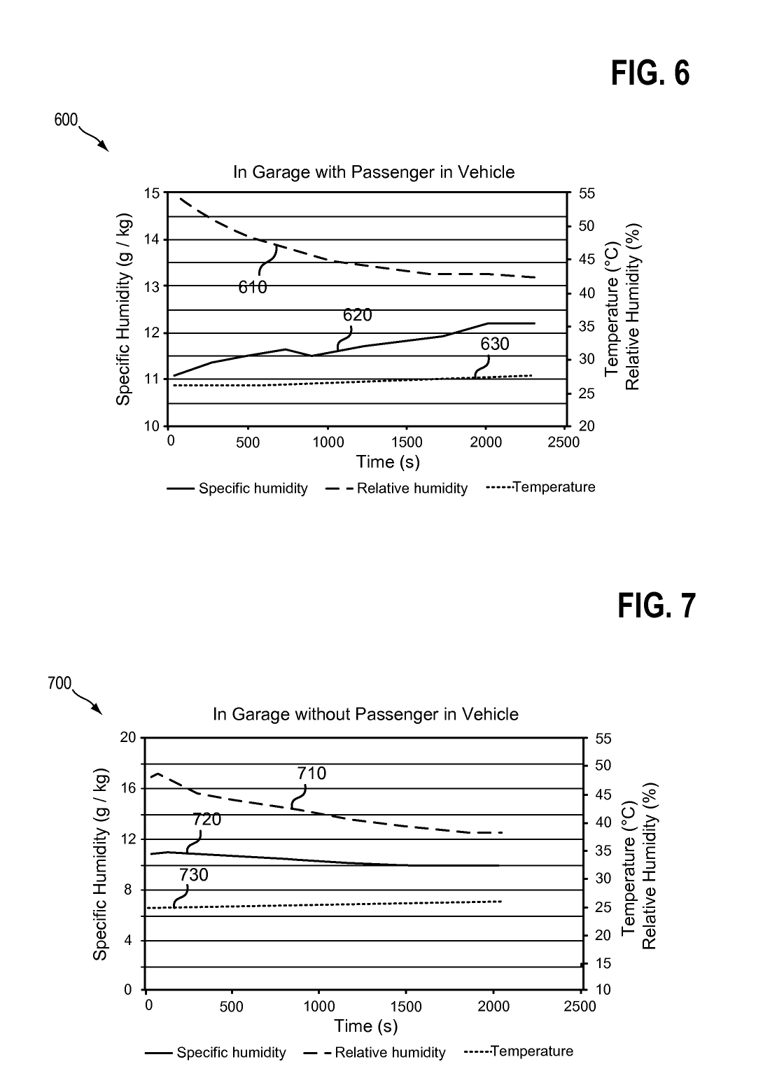

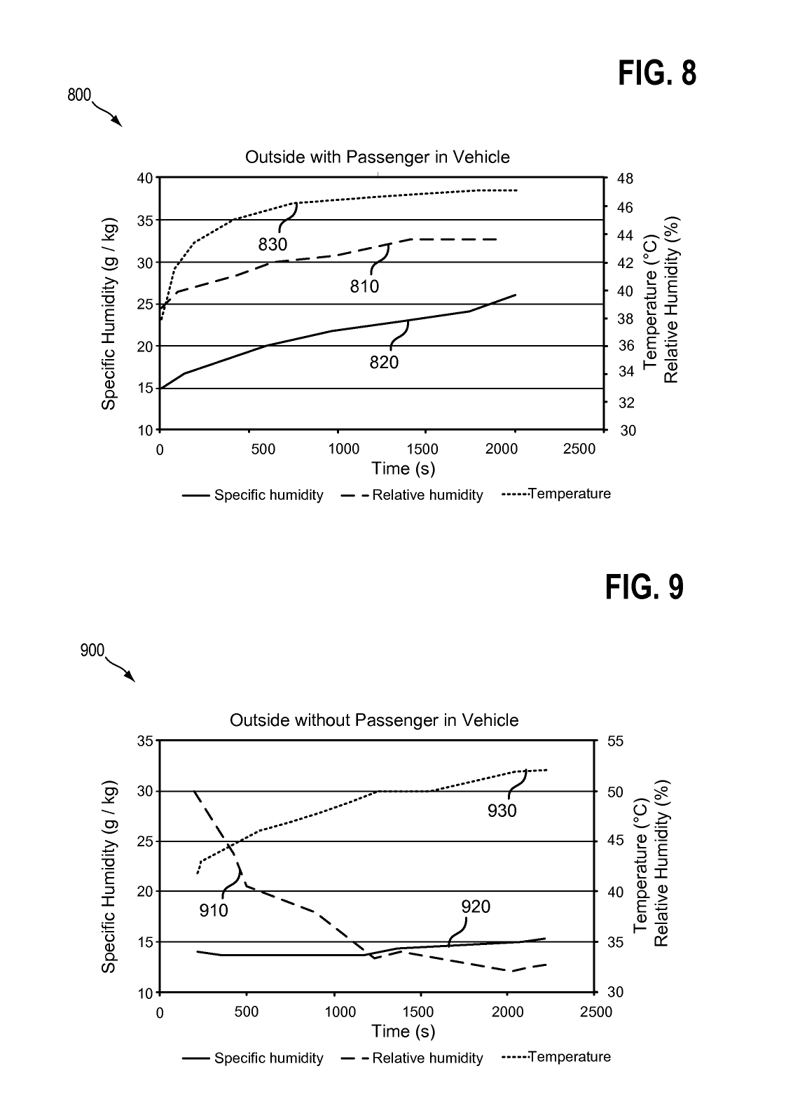

Now turning to FIGS. 6-9, they illustrate example plots of relative humidity, specific humidity, and temperature data with time for a vehicle in a confined space with and without a passenger in the vehicle (FIGS. 6, 7 respectively), and for a vehicle outside with and without a passenger in the vehicle (FIGS. 8, 9 respectively). Cabin temperature data may be measured and collected with one or more of above-described examples of HVAC temperature sensors, such as sensors 318 and 510. Humidity data may be measured and collected with one or more of the above-described examples of HVAC humidity sensors, such as sensors 482, 488, and 510.

Turning now to FIG. 6, it illustrates a chart 600 comprising temperature and humidity data for a vehicle parked indoors with a passenger inside the vehicle. Chart 600 shows that the specific humidity 620 in the vehicle cabin increases approximately 1 g/kg from approximately 11 g/kg to 12 g/kg over approximately 2000 s (33 min). During the same time period, the change in temperature 630 of the cabin is approximately 1° C., the cabin temperature increasing from approximately 26° C. to 27° C.

Turning now to FIG. 7, it illustrates a chart 700 comprising temperature and humidity data for a vehicle parked indoors without a passenger inside the vehicle. In comparison to chart 600, chart 700 illustrates a slight drop in specific humidity 720 by 1 g/kg from approximately 11 g/kg to 10 g/kg over approximately 2000 s (33 min). During the same time period, the change in temperature 730 of the cabin is about the same, increasing about 1° C. from 25° C. to 26° C. In both charts 600 and 700, the relative humidity decreases approximately 10%, decreasing from approximately 54% to approximately 42%, and decreasing from approximately 48% to 38% respectively over 2000 s.

FIGS. 6 and 7 indicate that for a vehicle located indoors, for example a vehicle parked in an enclosed space, specific humidity measurements may identify the presence of a passenger in the vehicle. Specifically, a rise in specific humidity of 1 g/kg observed over a 30 min period, may indicate the presence of a passenger in the vehicle. Furthermore, the presence of a passenger in the vehicle may not appreciably affect the cabin temperature or relative humidity.

Passenger respiration and perspiration may cause humidity changes in a vehicle cabin. Because the cabin temperature is maintained near 27° C. in FIGS. 6 and FIGS. 7, the 1 g/kg increase in specific humidity may be due to passenger respiration, as the conditions may not be conducive to cause excessive perspiration.

Turning now to FIG. 8, it illustrates a chart 800 comprising temperature and humidity data for a vehicle parked outdoors with a passenger inside the vehicle. FIG. 8 shows that the cabin temperature of a vehicle outside with a passenger 830 may increase more as compared to the cabin temperature of a vehicle inside with a passenger 630. As shown in FIG. 8, the cabin temperature of a vehicle outside 830 may increase from approximately 38° C. to 47° C. after 2000 s. A larger increase in specific humidity of the cabin of the vehicle outside with a passenger 820 may also occur as compared to the increase in specific humidity of the cabin of a vehicle inside with a passenger 620. As shown in FIG. 8, the specific humidity of the cabin of a vehicle outside with a passenger 820 may increase 11 g/kg from 15 g/kg to 26 g/kg after 2000 s. The relative humidity of the vehicle outside with a passenger 810 may increase from approximately 39% to 44%.

Turning now to FIG. 9, it illustrates a chart 900 comprising temperature and humidity data for a vehicle parked outdoors without a passenger inside the vehicle. FIG. 9 shows that the cabin temperature of a vehicle outside without a passenger 930 may increase more as compared to a cabin temperature of a vehicle inside without a passenger 730. As shown in FIG. 9, the cabin temperature of the vehicle outside without a passenger 930 may increase from approximately 42° C. to 52° C. after 2000 s. The change in the specific humidity of the cabin of the vehicle with a passenger 820 in FIG. 8 may be larger than the change in specific humidity of a cabin of a vehicle outside without a passenger 920. As shown in FIG. 9, the change in specific humidity of a cabin of a vehicle outside without a passenger 920 may increase approximately 0.5 g/kg after 2000 s. As such the change in the specific humidity of a vehicle outside without a passenger may be similar to the change in specific humidity for a vehicle inside without a passenger 720. The relative humidity of a vehicle outside without a passenger 920 may decrease from approximately 50% to 33%.

The temperature changes illustrated in FIGS. 8 and 9 (830 and 930 respectively) may result from combined sun load and radiant heat from a vehicle passenger. Comparison of the temperature data in FIGS. 8 and 9 indicate that the increase in temperature is primarily due to sun load since the rise in temperature is approximately 10° C. for both cases. The temperature data in FIGS. 6-7 (630 and 730 respectively) also indicate that the temperature increase due to radiant heat from a vehicle passenger is relatively small.

The changes in specific humidity in FIGS. 6 and 8 (620 and 820 respectively) may result from passenger respiration and passenger perspiration. Comparison of the specific humidity data in FIGS. 6 and 8 indicate that the contribution of passenger respiration to the increase in specific humidity in FIG. 6 is small (e.g. 1.5 out of 11 g/kg increase). On the other hand, the contribution of passenger perspiration to the increase in specific humidity in FIG. 8 is large, the contribution being approximately 9.5 g/kg out of the 11 g/kg increase.

Accordingly, in one example, a method may measure changes in cabin specific humidity to detect the presence of a passenger in the vehicle, for example by differentiating the different data as explained with regard to FIGS. 6-9. When the vehicle is inside, or when the temperature is low, or when the sun load is low, an increase in specific humidity of the vehicle cabin may be smaller, the increase in specific humidity of the cabin being solely due to passenger respiration (e.g., 620). On the other hand, when the vehicle is outdoors and exposed to a high sun load, or when the temperature is high, an increase in the specific humidity of the vehicle cabin may be larger, the increase in the specific humidity of the cabin being due to passenger perspiration in addition to passenger respiration (e.g., 820). Furthermore, when there is no passenger in the vehicle, the change in specific humidity is near 0 (e.g., 720, 920).

In contrast, measuring changes in cabin relative humidity changes may not be as reliable an indicator for the presence of a passenger in the vehicle, although in some examples methods may further utilize relative humidity changes, if desired.

Turning now to FIG. 10, it illustrates a flow chart for an example method 1000 for controlling operation based on detecting the presence of a passenger in a stationary vehicle. Method 1000 may be executed by HVAC system 320, or within control system 190 or within a separate ECU residing in control system 190. Method 1000 begins at 1010, where current vehicle operating conditions such as engine torque, vehicle speed, battery state-of-charge (SOC) are estimated and/or measured.

Next, method 1000 continues at 1020, where it is determined if vehicle off conditions have been met. For example, vehicle off conditions may comprise the engine being off and the vehicle being parked/stationary. Vehicle off conditions may further comprise the driver being absent, for example indicated by an absence of the remote key fob 340 as sensed using the remote key fob sensor 341. Further still, vehicle off conditions may further comprise the engine being off and the vehicle being parked for a time greater than a threshold time. If the vehicle off conditions are not met, method 1000 ends. For example, if the engine is off and the vehicle has been parked for more than a threshold time, method 1000 may end so that the vehicle resources are not exhausted from continually determining if a passenger is present in the vehicle cabin beyond the threshold time. As an example, the threshold time may be 30 minutes, 45 minutes, or 60 minutes. If the vehicle off conditions are met, method 1000 continues to 1030.

At 1030, the HVAC fan is intermittently turned on, or powered at a partial level, in order to circulate at least some cabin air for a circulating time period, the time period selected based on operating conditions. Circulating the cabin air may improve cabin environmental uniformity, and further enable circulation of cabin air from a uniform cabin environment in the vicinity of the vehicle sensors, such as vehicle humidity sensors (e.g. 198, 482, 484, 488, 510, 520). For example, if a passenger is present in the rear seat of the vehicle, while a humidity sensor is measuring humidity within the HVAC ducts (e.g., sensors 488, 482, 484), then the measured humidity by sensors in the front of the vehicle cabin may not accurately reflect the presence of the passenger in the vehicle cabin without first circulating the cabin air. Circulating the cabin air prior to and/or during sampling of environmental conditions may thus increase the reproducibility of cabin sensor measurements for cabin environmental conditions. Circulating the cabin air may occur over the selected circulating time period. For example, the circulating time period may be 30 seconds, or the circulating time period may be shorter or longer than 30 seconds. The circulating time period may also be predetermined or may be set by the vehicle operator.

Next, method 1000 continues at 1040, where the vehicle environmental conditions are determined and/or measured. Examples of vehicle environmental conditions include cabin temperature, cabin specific humidity, sun load, portal status (e.g., whether vehicle portals such as windows or doors are open or closed), and the like. After vehicle environmental conditions are measured, method 1000 continues at 1050, where it is determined if a change in SH is greater than a threshold change in SH, ΔSHₜₕ.

Method 1000 may be executed at periodic intervals, for example at one minute intervals. Therefore, when the engine is off and the vehicle is parked, method 1000 may execute 1030, 1040, and 1050 at periodic intervals, for example at one minute intervals. Accordingly, changes in SH may be evaluated over each measurement interval and/or over a plurality of measurement intervals. For example, a threshold change in SH, ΔSHₜₕ, may be defined over one measurement period and/or over a plurality of measurement periods, when determining the presence of a passenger in the vehicle cabin. As an example, ΔSHₜₕ may be set at 1 g/kg over a 1 minute period. Accordingly, if SH increases above 1 g/kg after 1 minute, a presence of a passenger in the cabin may be determined. As a further example, ΔSHₜₕ may be set over a longer time interval to allow more measurements to be made before determining the presence of a passenger in the cabin. As another example, ΔSHₜₕ may be set at 5 g/kg over a 5 minute period. Accordingly, if SH increases above 5 g/kg after 5 minutes, a presence of a passenger in the cabin may be determined.

Further still, ΔSHₜₕ may be set according to the environmental conditions in order to detect the presence of a vehicle passenger. For example if the vehicle is parked inside, or if the sun load is small, or the temperature is low (e.g., conditions such as those of FIGS. 6, 7), ΔSHₜₕ may be set at a smaller value as compared to when the vehicle is parked outside with a high sun load, or when the temperature is high (e.g., conditions such as those of FIGS. 8-9). As a further example, under environmental conditions where the presence of a passenger may generate a gradual increase in cabin specific humidity over time (e.g., conditions such as those of FIG. 6), ΔSHₜₕ may be set at a smaller value and may be set over a longer time interval to allow more measurements to be made before evaluating the data to determine the presence of a passenger in the cabin. Conversely, under environmental conditions where the presence of a passenger can generate a rapid increase in cabin specific humidity with time (e.g., conditions such as those of FIG. 8), ΔSHₜₕ may be set at a higher value and may be set over a shorter time interval to allow for a quicker determination of the presence of a passenger in the cabin. Under environmental conditions where the presence of a passenger can generate a rapid increase in cabin specific humidity with time, a quicker determination of the presence of a passenger in the cabin may allow for a quicker response of the vehicle systems via method 1000 to the presence of a passenger in the cabin based on the environmental conditions.

t, method 1000 continues at 1070 where it is determined if current environmental conditions are beyond threshold environmental conditions. Environmental conditions beyond threshold environmental conditions may comprise environmental conditions exceeding upper threshold environmental conditions, and may further comprise environmental conditions exceeding lower threshold environmental conditions. For example, 1070 compares the current cabin temperature, cabin specific humidity, sun load, portal status, and the like, measured in 1040 to upper and lower threshold values thereof The upper and lower threshold values may be predetermined or may be set by the vehicle operator. For example, the cabin temperature upper threshold may be 30° C., the cabin specific humidity upper threshold may be 15 g/kg, the sunload upper threshold may be an upper threshold level of solar radiant heat entering the vehicle cabin, the upper or lower threshold portal status may be closed, and the like. As a further example if a lower threshold cabin temperature may be 12° C. Accordingly, if at least one or a plurality, or a predetermined combination of environmental conditions are beyond upper and/or lower threshold environmental conditions then the method 1000 continues at 1080. If at least one or a plurality, or a predetermined combination of environmental conditions are not beyond upper and/or lower threshold environmental conditions then the method 1000 continues at 1090.

At 1080, method 1000 executes responsive action to mitigate the one or more environmental conditions that are beyond the one or more threshold environmental conditions. For example, if the cabin temperature is exceeding the upper threshold cabin temperature, method 1000 (at 1080) may direct the HVAC controller to turn on the air conditioning to cool the cabin, and may also direct the HVAC controller to open one or more vehicle portals, for example, if the vehicle portal statuses are closed. As a further example, if the cabin temperature is below a lower threshold cabin temperature, method 1000 at 1080 may direct the HVAC controller to heat the cabin, and may further adjust operation such that the vehicle portals are in their closed states.

At 1090, method 1000 may send a notification of the presence of a passenger in the vehicle. Sending a notification may comprise sounding the horn, sending a message or calling a vehicle operator through their mobile device, sending an alert to the remote key fob, and the like. The vehicle operator may comprise the last driver of the vehicle, the vehicle owner, and other vehicle drivers. Still further other entities may also be notified, based on pre-programmed information in the message center, including user-inputted information. Note that the example process flows described herein can be used with various engine and/or vehicle system configurations. The process flows described herein may represent one or more of any number of processing strategies such as event-driven, interrupt-driven, multi-tasking, multi-threading, and the like. As such, various acts, operations, or functions illustrated may be performed in the sequence illustrated, in parallel, or in some cases omitted. Likewise, the order of processing is not necessarily called for to achieve the features and advantages of the examples described herein, but is provided for ease of illustration and description. One or more of the illustrated acts or functions may be repeatedly performed depending on the particular strategy being used. Further, the described acts may graphically represent code to be programmed into the computer readable storage medium in the engine control system.

In this manner, a method may comprise during a vehicle off condition comprising when a vehicle engine is off, and the vehicle is parked, adjusting a condition responsive to a passenger presence in the vehicle, the passenger presence based on vehicle cabin humidity. The vehicle cabin humidity may be based on a humidity sensor of a vehicle HVAC system, and cabin air may be circulated for a duration prior to measuring the vehicle cabin humidity. The vehicle cabin humidity may be a specific humidity, wherein the passenger presence is based on a change in the specific humidity of the vehicle cabin over an interval. Adjusting operation of the HVAC system may comprise adjusting operation to change in a temperature of the vehicle cabin, including increasing operation of a fan of an HVAC system of the vehicle. Adjusting operation of the HVAC system may further include generating a notification based on the passenger presence.

The vehicle off condition may further comprise when a remote key fob is not present at the vehicle, and when the vehicle engine is off and the vehicle is parked for a time less than a threshold time. The passenger presence may be based on ambient conditions, and may further be based on a sun load. Furthermore, the passenger presence may be based on whether the vehicle is in an enclosure.

In another example, a method may comprise during a vehicle off condition, periodically measuring a vehicle cabin humidity and in response to a threshold increase in the vehicle cabin humidity, sending a notification based on the threshold increase, and adjusting an HVAC system operation to control the vehicle cabin temperature below a threshold temperature.

In another example, a method may comprise during a vehicle off condition, measuring an outdoor ambient humidity, measuring a vehicle cabin humidity, and based on a change of a difference between the outdoor ambient humidity and the vehicle cabin humidity, operating the vehicle HVAC system to control the vehicle cabin temperature below a threshold temperature.

In another example, a method may comprise during a passenger present condition, operating a vehicle HVAC system to control a cabin temperature, the passenger present condition comprising when a vehicle cabin humidity changes by a threshold amount during an interval

It will be appreciated that the configurations and routines disclosed herein are exemplary in nature, and that these specific examples are not to be considered in a limiting sense, because numerous variations are possible. For example, the above technology can be applied to sedans, trucks, vans, buses, tractors, and other vehicles with various cabin dimensions. The subject matter of the present disclosure includes all novel and non-obvious combinations and subcombinations of the various systems and configurations, and other features, functions, and/or properties disclosed herein.

The following claims particularly point out certain combinations and subcombinations regarded as novel and non-obvious. These claims may refer to “an” element or “a first” element or the equivalent thereof. Such claims are to be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application.

1. A method, comprising:
during a vehicle off condition comprising when a vehicle engine is off, and a vehicle is parked,
adjusting a condition responsive to a determination of a passenger presence in a vehicle cabin, the determination based on a sun load and further based on changes in relative humidity and specific humidity in the cabin, including an increase in the specific humidity and a decrease in the relative humidity over an interval.

2. The method of claim 1, wherein the specific humidity is based on measurements of a humidity sensor of a vehicle HVAC system.

3. The method of claim 2, further comprising circulating cabin air for a duration prior to measuring the specific humidity.

4. (canceled)

5. The method of claim 3, wherein the increase in the specific humidity is greater than a threshold increase in specific humidity over the interval.

6. The method of claim 5, wherein adjusting the condition includes adjusting operation of the vehicle HVAC system to change a vehicle cabin temperature.

7. The method of claim 6, wherein the determination of a passenger presence is further based on ambient conditions.

8. The method of claim 7, wherein the vehicle off condition further comprises when a remote key fob is not present at the vehicle.

9. The method of claim 8 wherein the vehicle off condition further comprises when the vehicle engine is off and the vehicle is parked for a time less than a threshold time.

10. The method of claim 5, wherein the threshold increase in specific humidity is reduced for a smaller sun load, and wherein the threshold increase in specific humidity is increased for a larger sun load.

11. The method of claim 1, wherein adjusting the condition includes increasing operation of a fan of a vehicle HVAC system.

12. The method of claim 1, wherein the determination of a passenger presence is further based on whether the vehicle is in an enclosure.

13. The method of claim 1, wherein adjusting the condition includes generating a notification based on the passenger presence.

14. A system, comprising:
a vehicle with an HVAC system;
a relative humidity sensor;
a controller comprising executable instructions for adjusting the HVAC system based on a relative humidity in a vehicle cabin sensed by the sensor and a specific humidity in the cabin calculated based on the relative humidity to provide an operator-indicated cabin environmental condition during a first vehicle on mode, and during a vehicle off mode, adjusting the HVAC system responsive to a determination of a passenger presence in the vehicle, the determination based on a sun load and further based on changes in the relative humidity and the specific humidity, including an increase in the specific humidity and a decrease in the relative humidity over an interval, the increase in the specific humidity being greater than a threshold increase in specific humidity over the interval.

15. A method, comprising:
during a vehicle off condition,
responsive to a determination of a passenger presence in a vehicle cabin, the determination based on a sun load, and further based on changes in relative humidity and specific humidity in the cabin, including an increase in the specific humidity and a decrease in the relative humidity over an interval, the increase in the specific humidity being greater than a threshold increase in specific humidity over the interval.
sending a notification based on the threshold increase, and
operating an HVAC system to control a vehicle cabin temperature below a threshold temperature.

16. A method, comprising:
during a vehicle off condition,
responsive to a determination of a passenger presence in a vehicle cabin, the determination based on a sun load, and further based on changes in relative humidity and specific humidity in the cabin, including an increase in the specific humidity and a decrease in the relative humidity over an interval, and further based on a change in a difference between an outdoor ambient humidity and the relative humidity, operating a vehicle HVAC system to control a vehicle cabin temperature below a threshold temperature.

17. A method comprising:
during a passenger present condition,
operating a vehicle HVAC system to control a temperature in a vehicle
cabin, the passenger present condition determined based on a sun load and on changes in relative humidity and specific humidity in the cabin, including an increase in the specific humidity and a decrease in the relative humidity over an interval, the increase greater than a threshold increase in specific humidity over the interval.
